(19) United States
(12) Patent Application Publication
(10) Pub. No.: US 2003/0015631 A1
(43) Pub. Date: Jan. 23, 2003

(54) Adjustment structure for television pillow

(76) Inventor: Fa-Yu Chu, Taipei (TW)

Correspondence Address: BRUCE H. TROXELL, SUITE 1404, 5205 LEESBURG PIKE, FALLS CHURCH, VA, 22041, US

(21) Appl. No.: 10/187,976

(22) Filed: Jul. 3, 2002

(30) Foreign Application Priority Data
Jul. 20, 2001 (TW) 90212364

(51) Int. Cl. B68G 5/00

(52) U.S. Cl. 248/118

(57) ABSTRACT

Adjustment structure for television pillow, including a television frame, a board seat and a subsidiary board. The television frame is for accommodating therein a television and is mounted on one side of the board seat. The bottom of the board seat is formed with a guide slot for a support rod assembly of a seat to insert therethrough. A clip member clips and pivotally connects the support rod assembly with the board seat. The board seat can be forward or rearward tilted about the support rod assembly so as to adjust the watching angle of the television. The subsidiary board and the board seat are pivotally connected by means of a pivot rod and a clip body. The subsidiary board can be pivoted upward relative to the board seat to change the supporting angle for a neck. Accordingly, the watching angle of the television and the supporting angle of front seat pillow can be independently adjusted without conflicting with each other.

### BACKGROUND OF THE INVENTION

The present invention is related to an adjustment structure for television pillow. A board seat is pivotally disposed on a support rod assembly of a car seat. A television frame is mounted on one side of the board seat. A subsidiary board is pivotally connected with the other side of the board seat. The board seat can be forward or rearward tilted about the support rod assembly so as to adjust the watching angle of the television. The subsidiary board can be independently pivoted relative to the board seat to change the supporting angle for the head of a front seat passenger without conflicting with the adjustment of the watching angle of the television.

Car-used stereo and television have been more and more popular. Currently, the car-used television is inlaid in a cavity of the seat pillow of the car for a user to see.

After the car-used television is mounted in the seat pillow, in the case that the seat pillow is supported by a normal angle, the rear seat passenger can hardly clearly see the television. The display angle of the television cannot be adjusted so that it is inconvenient to use the car-used television. Moreover, the car-used television is generally adhered to the seat pillow or connected therewith by screws. Such fixing measure can hardly securely fixedly mount the television in the seat pillow. The support rods of the seat pillow can be adjusted to change the supported position of the seat pillow. However, such adjustment is not for the angle of the television on rear side of the seat pillow. In the case that the rear seat passenger adjusts the seat pillow for good watching angle of the television, the neck of the front seat passenger may be not well supported.

### SUMMARY OF THE INVENTION

It is therefore a primary object of the present invention to provide an adjustment structure for car-used television pillow. A board seat is pivotally disposed on a support rod assembly of a car seat. A television frame is mounted on one side of the board seat and a subsidiary board is pivotally connected with the other side of the board seat. The board seat can be forward or rearward tilted about the support rod assembly so as to adjust the watching angle of the television. The subsidiary board can be independently pivoted relative to the board seat to change the supporting angle for the head of a front seat passenger without conflicting with the adjustment of the watching angle of the television.

It is a further object of the present invention to provide the above adjustment structure for car-used television pillow, in which the support rod assembly includes two opposite support rods and a linking rod connected between the support rods. The support rods are formed with perpendicular transverse worms opposite to each other. The worms have threads in the same direction. Two ends of the linking rod are formed with thread holes corresponding to the worms, whereby the worms can be screwed into the thread holes. By means of changing the screwing depth of the support rods in the linking rod, the distance between the support rods can be adjusted. Therefore, the support rod assembly can be widely adapted to different distances between the insertion sections of the seats of various car models.

It is still a further object of the present invention to provide the above adjustment structure for car-used television pillow, in which a fixing member is fitted on bottom end of each of the support rods. The fixing member has various outer diameters for tightly fitting into the insertion sections of various types of car seats. The fixing member has such an inner diameter for one single type of support rod to insert therein. Therefore, by means of the fixing members which have different outer diameters, while having unified inner diameter, the support rods of the support rod assembly can be unified to greatly lower manufacturing cost.

The present invention can be best understood through the following description and accompanying drawings wherein:

### BRIEF DESCRIPTION OF THE DRAWINGS

FIG. 1 is a perspective exploded view of the present invention;

FIG. 2 is a perspective assembled view of the present invention;

FIG. 3 is a side sectional view of the present invention;

FIG. 4 is a perspective exploded view of the support rod assembly of the present invention;

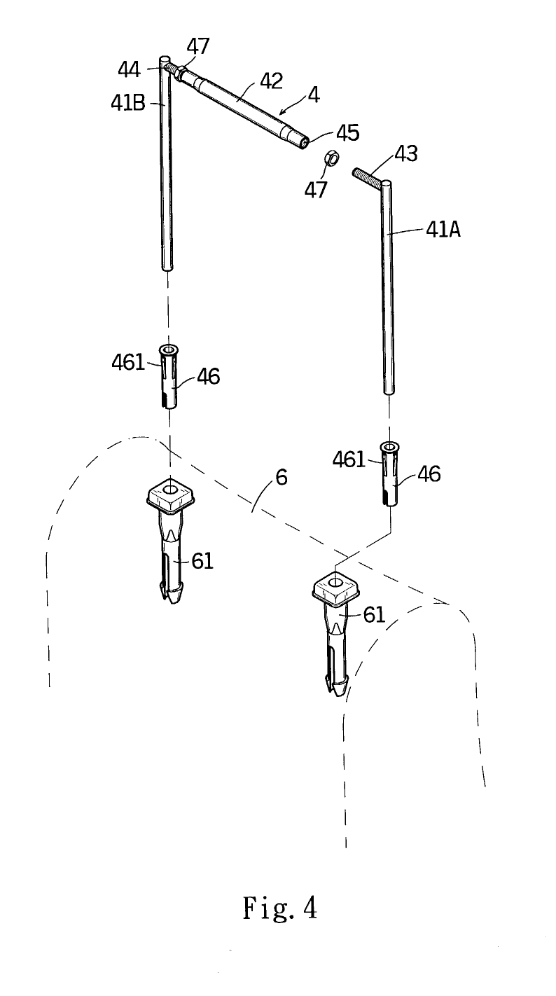

FIG. 5 is a view showing that the support rod assembly of the present invention is connected with the seat;

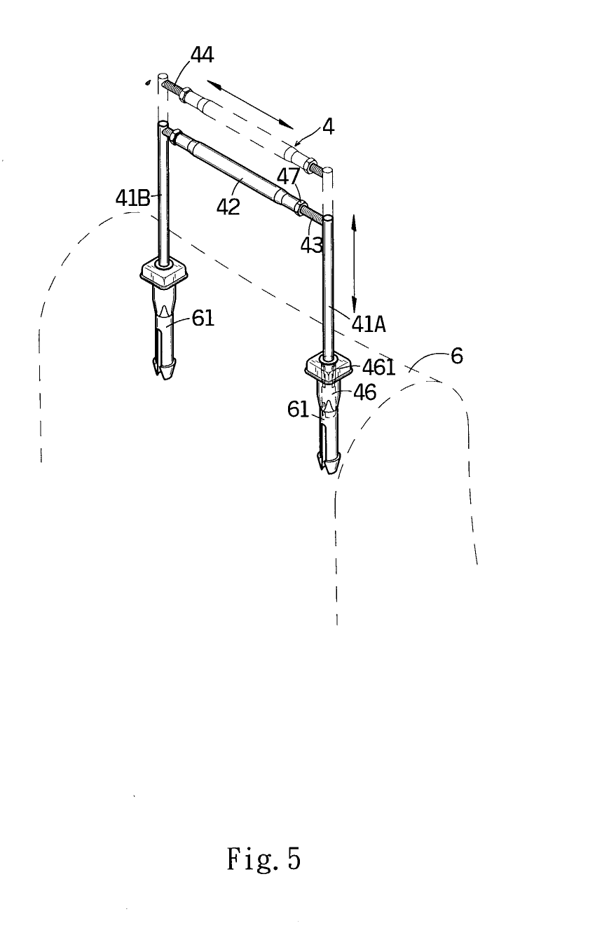

FIG. 6 shows the adjustment of the present invention in one state;

FIG. 7 shows the adjustment of the present invention in another state;

FIG. 8 is a perspective exploded view of a second embodiment of the present invention;

FIG. 9 is a perspective assembled view of the second embodiment of the present invention;

FIG. 10 is a side sectional view of the second embodiment of the present invention;

FIG. 11 shows the adjustment of the second embodiment of the present invention in one state; and

FIG. 12 shows the adjustment of the second embodiment of the present invention in another state.

### DETAILED DESCRIPTION OF THE PREFERRED EMBODIMENTS

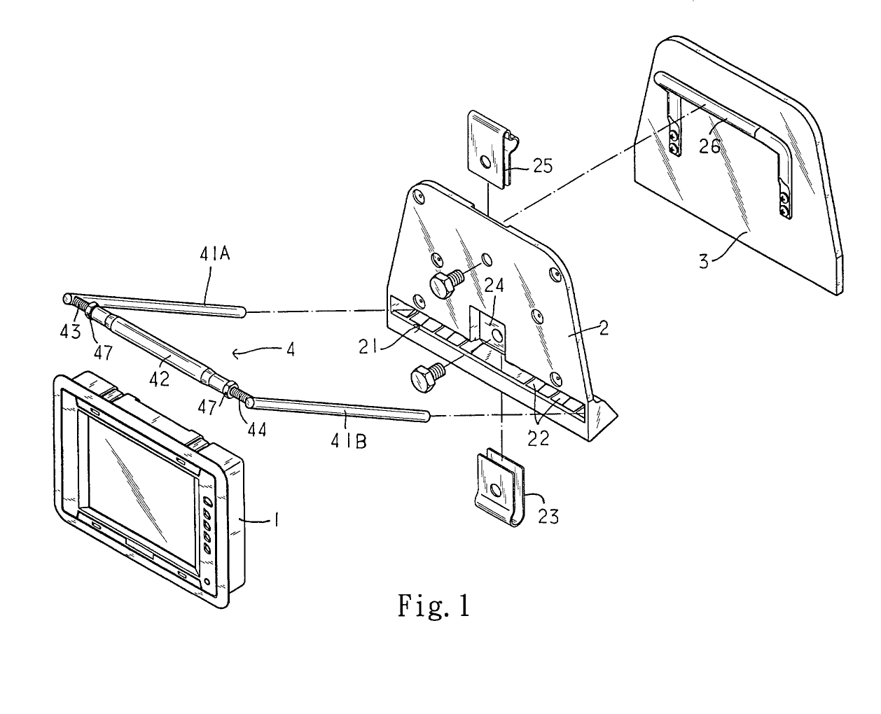

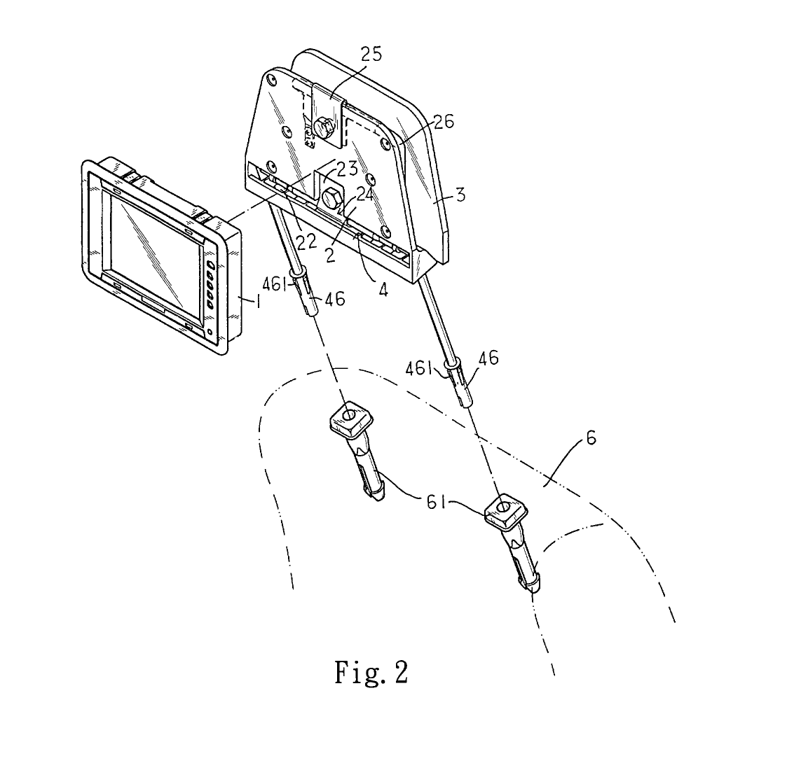

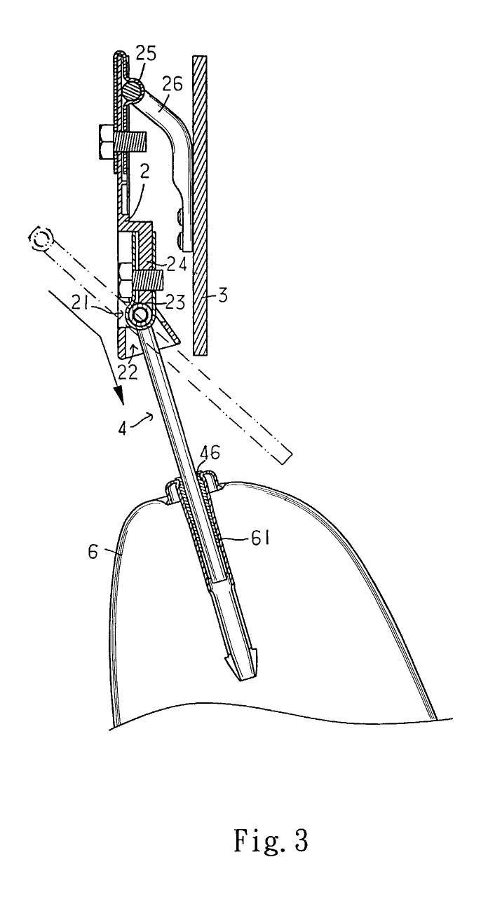

Please refer to FIGS. 1 to 3. The adjustment structure for television pillow of the present invention includes a television frame 1, a board seat 2 and a subsidiary board 3. The television frame 1 has an internal receiving space for accommodating therein a car-used television. The car-used television is enclosed in and protected by the television frame 1. The bottom side of the television frame 1 is fixed on one side of the board seat 2 by adhesion or locking. The board seat 2 is an upright board body. A portion of the board seat 2 near lower end thereof is formed with a transverse guide slot 21 passing through the board body. The bottom of the board seat 2 is formed with multiple insertion sockets 22 under the guide slot 21. The insertion sockets 22 communicate with the guide slot 21. The insertion sockets 22 are arranged at different intervals.

The present invention further includes a support rod assembly 4 composed of two opposite support rods 41A, 41B and a linking rod 42 connected between the support rods. The upper ends of the support rods 41A, 41B are formed with perpendicular transverse worms 43, 44 opposite to each other. The worms 43, 44 have threads in the same direction. Two ends of the linking rod 42 are formed with thread holes 45 corresponding to the worms 43, 44. The worms 43, 44 can be screwed into the thread holes 45. When adjusting the distance between the support rods 41A, 41B, the screwing depth of at least one of the support rods 41A, 41B in the linking rod 42 is changed to directly adjust the distance. After adjusted to a predetermined position, by means of screwed members 47 disposed on the worms 43, 44, the support rods 41A, 41B are tightened with the linking rod 42 in the position. Accordingly, the distance between the support rods 41A, 41B can be quickly and easily adjusted so that the support rod assembly 4 can be widely adapted to the distance between the insertion sections 61 of various car seats 6.

In addition, a fixing member 46 which can be a sleeve is fitted on bottom end of each of the support rods 41A, 41B, The fixing member 46 has an inner diameter corresponding to the diameter of the support rod. The fixing member can be designed with different sizes adaptable to various car models. In use, the fixing members 46 are directly inserted and engaged in the insertion sections 61 of the car seat 6. Accordingly, via the fixing members 46, the support rods 41A, 41B can be suitably inserted in the insertion sections 61 with different diameters. Therefore, the support rods 41A, 41B can be designed with unified diameter. The top end of the fixing member 46 can be formed with thrust ribs 461 for securely connecting with the insertion sections 61.

The insertion sockets 22 of the board seat 2 are outward diverged from upper side to lower side. After the distance between the support rods 41A, 41B is adjusted, the support rod assembly 4 can be inserted through the insertion sockets 22 spaced by a distance corresponding to the distance between the support rods 41A, 41B. Thereafter, the board seat 2 can be forward or rearward tilted and adjusted relative to the support rod assembly 4 within the downward diverging angle of the insertion sockets 22. A clip member 23 pivotally clips the linking rod 42 of the support rod assembly 4. The board seat 2 is formed with a clip section 24 corresponding to the clip member 23. Accordingly, by means of the clip member 23, the support rod assembly 4 is pivotally fixed on the clip section 24 and connected with the board seat 2. Therefore, the board seat 2 can be pivoted about the linking rod 42, whereby the inclination angle of the television frame 1 mounted on the board seat 2 can be easily adjusted to achieve an optimal watching angle.

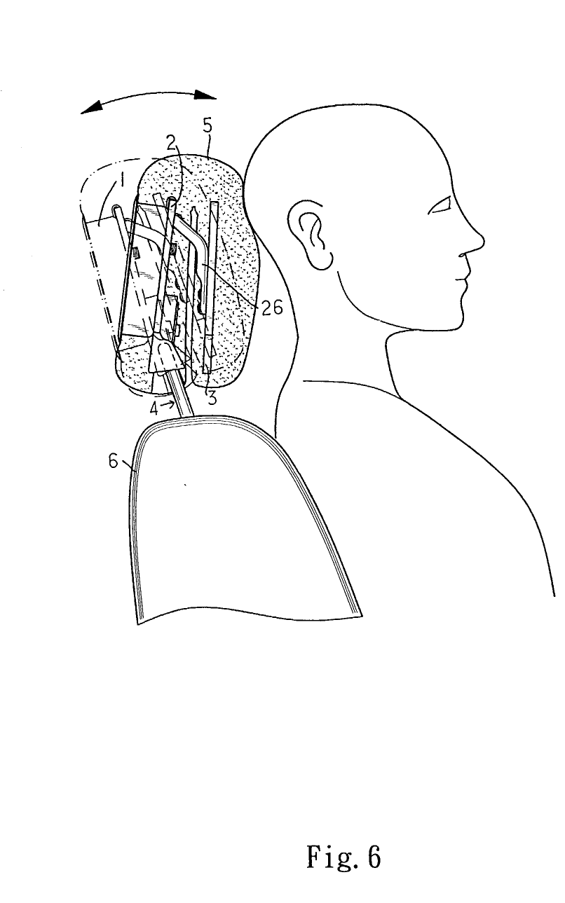

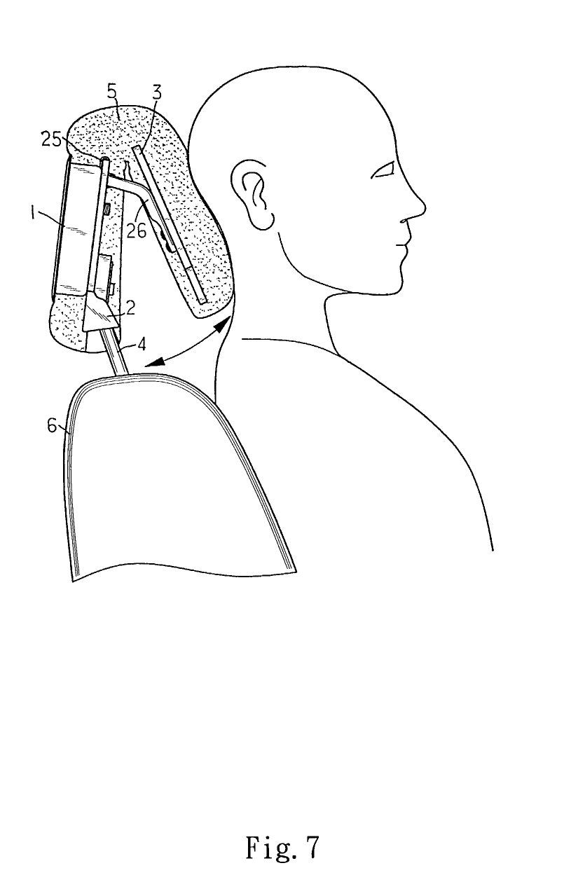

The other side of the board seat 2 is pivotally connected with the subsidiary board 3. A substantially tubular U-shaped pivot rod 26 is fixed on the subsidiary board 3 by locking members or welding. The top section of the pivot rod 26 is outward bent from the subsidiary board 3. The top section of the pivot rod 26 is leant against the board seat 2 to space the board seat 2 from the subsidiary board 3 by a certain distance. A clip body 25 clips the top section of the pivot rod 26 and the top section of the board seat 2 so as to pivotally connect the subsidiary board 3 with the board seat 2. Accordingly, the subsidiary board 3 can be pivoted about the pivot rod 26 relative to the board seat 2 instead of the original seat pillow for supporting the head and neck of a front seat passenger (as shown in FIGS. 6 and 7). It should be noted that the board seat 2 and the subsidiary board 3 are enclosed by a soft wrappage 5 to provide a soft supporting effect. According to the above structure, when adjusting the board seat 2 on which the television frame 1 is mounted to achieve an optimal watching angle for the rear seat passenger, the subsidiary board 3 can be simultaneously pivoted in reverse direction to adjust the supporting angle of the pillow for the head and neck of the front seat passenger. Accordingly, the watching angle of the television and the supporting angle for the head and neck can be independently adjusted without interfering with each other.

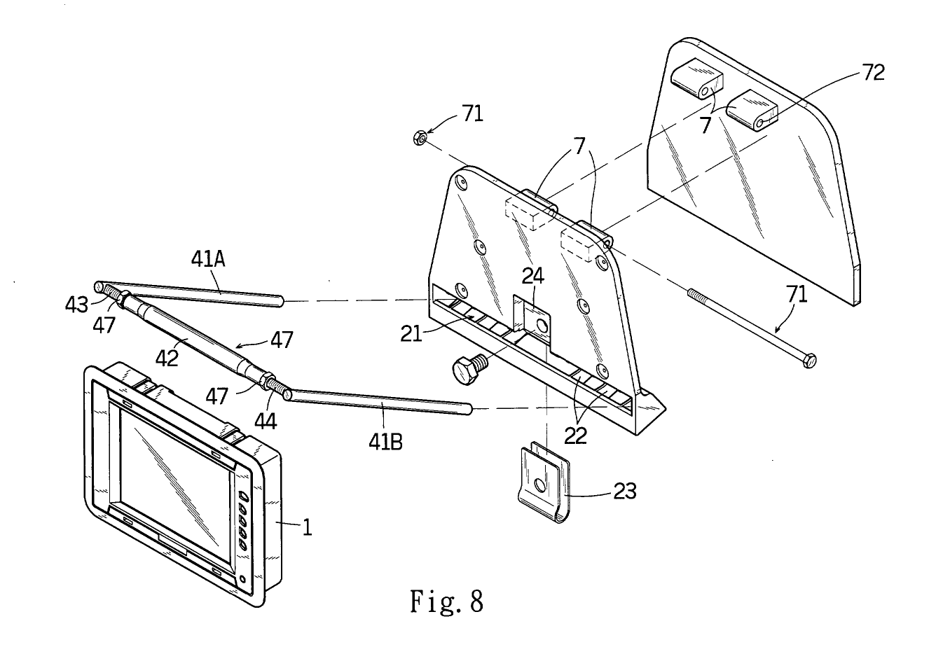

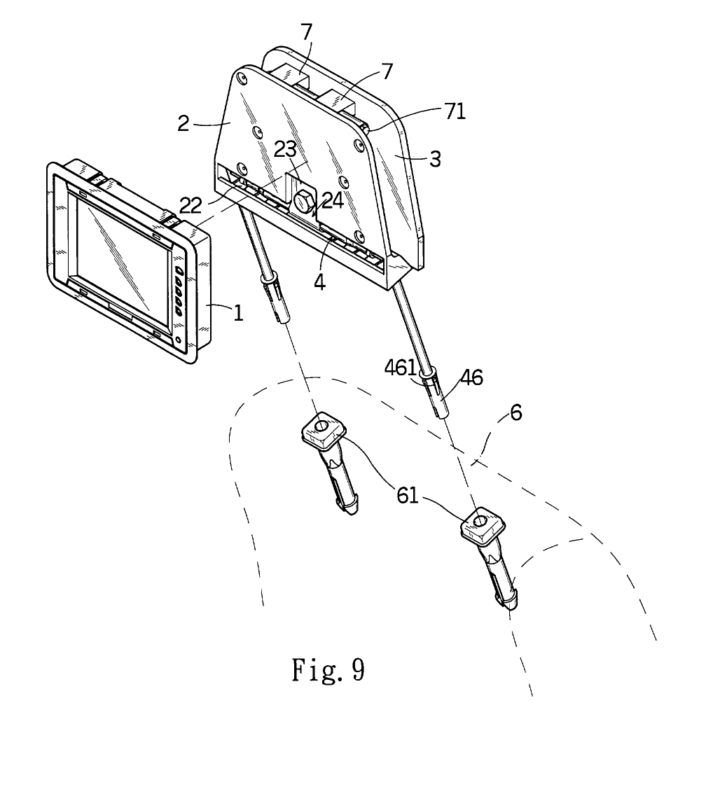

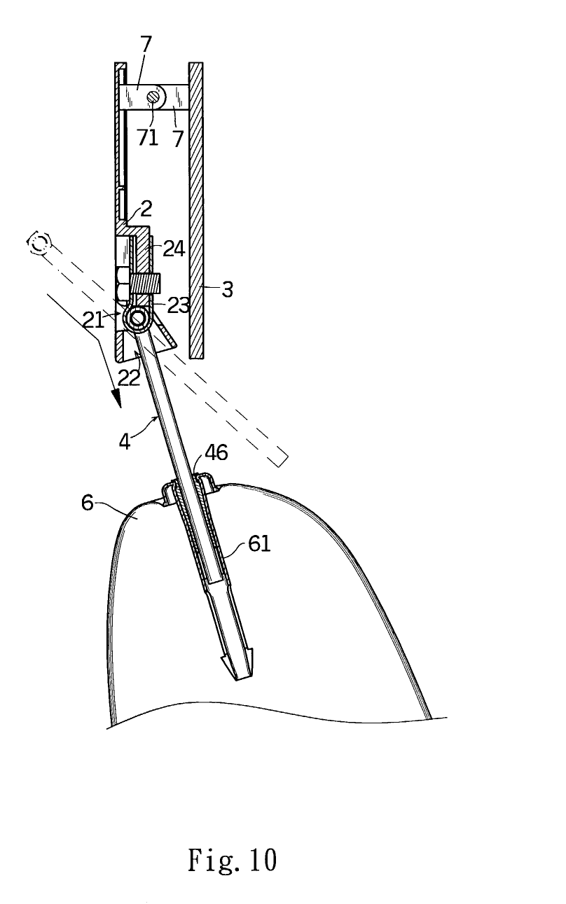

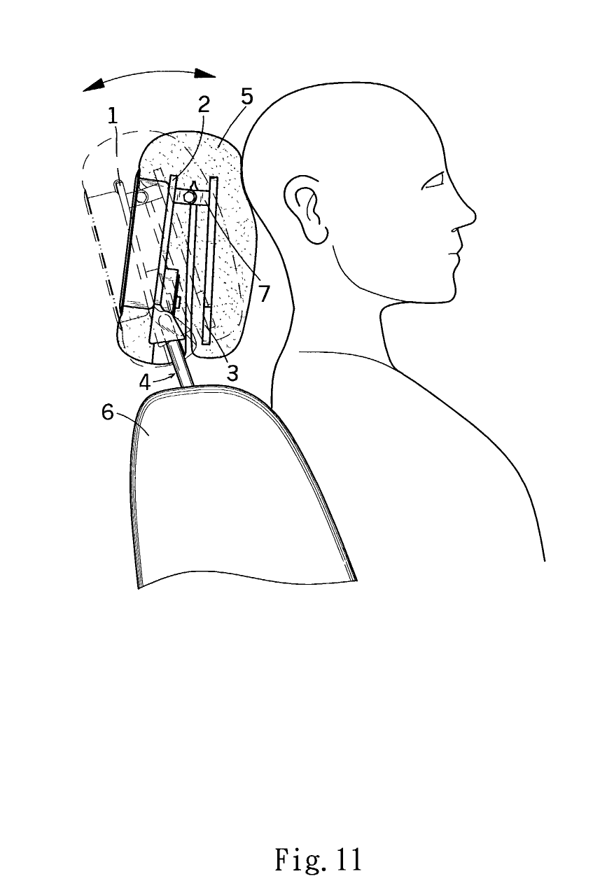

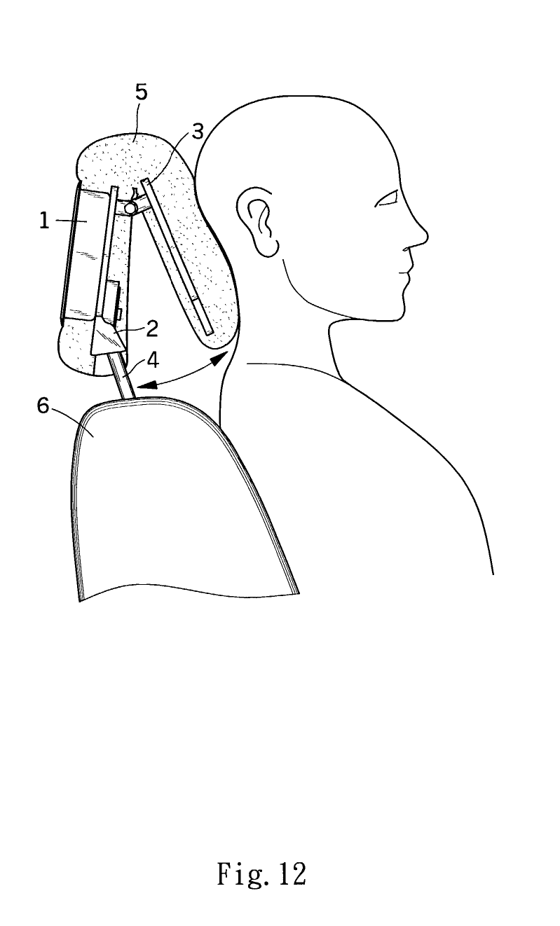

Alternatively, the board seat 2 and the subsidiary board 3 can be pivotally connected by interlaced connecting blocks 7 respectively disposed on the board seat 2 and the subsidiary board 3. Each connecting block 7 is a projecting block body. The connecting blocks 7 have bight top ends formed with coaxially aligned holes 72. A shaft 71 is passed through the holes 72 to serially pivotally connect the connecting blocks 7. Accordingly, the top ends of the connecting blocks 7 respectively abut against the board seat 2 and the subsidiary board 3. The board seat 2 and the subsidiary board 3 can be pivoted about the shaft 71 relative to each other. Therefore, the subsidiary board 3 can substitute for the original seat pillow to provide a supporting effect for the head and neck of the front seat passenger (as shown in FIGS. 8 to 12).

The above embodiments are only used to illustrate the present invention, not intended to limit the scope thereof. Many modifications of the above embodiments can be made without departing from the spirit of the present invention.

What is claimed is:

1. Adjustment structure for television pillow, comprising:
a board seat which is an upright board body, a bottom section of the board seat being formed with a guide slot for a support rod assembly of a seat to insert therethrough, a clip member clipping and pivotally connecting the support rod assembly with the board seat, whereby the board seat can be forward or rearward tilted and pivotally adjusted about the support rod assembly; and
a television frame having an internal receiving space open to one side of the television frame for accommodating therein a television, the other side of the television frame being pivotally connected with one side of the board seat, whereby the watching angle of the television mounted in the television frame on back side of the pillow can be adjusted.

2. Adjustment structure for television pillow as claimed in claim 1, wherein a subsidiary board is pivotally connected with upper edge of the other side of the board seat, whereby the subsidiary board can be pivoted upward relative to the board seat to change the supporting angle for rear side of a head.

3. Adjustment structure for television pillow as claimed in claim 2, wherein the subsidiary board and the board seat are pivotally connected by means of a pivot rod and a clip body pivotally clipping the pivot rod and the board seat.

4. Adjustment structure for television pillow as claimed in claim 1, wherein the guide slot is a transverse guide slot formed on a portion of the board seat near lower end thereof, the guide slot passing through the board seat.

5. Adjustment structure for television pillow as claimed in claim 2, wherein the guide slot is a transverse guide slot formed on a portion of the board seat near lower end thereof, the guide slot passing through the board seat.

6. Adjustment structure for television pillow as claimed in claim 3, wherein the guide slot is a transverse guide slot formed on a portion of the board seat near lower end thereof, the guide slot passing through the board seat.

7. Adjustment structure for television pillow as claimed in claim 4, wherein the bottom of the board seat is formed with multiple insertion sockets under the guide slot, the insertion sockets communicating with the guide slot, the insertion sockets being arranged at different intervals, whereby the support rods of the support rod assembly spaced by different distances can be inserted through suitable insertion sockets.

8. Adjustment structure for television pillow as claimed in claim 5, wherein the bottom of the board seat is formed with multiple insertion sockets under the guide slot, the insertion sockets communicating with the guide slot, the insertion sockets being arranged at different intervals, whereby the support rods of the support rod assembly spaced by different distances can be inserted through suitable insertion sockets.

9. Adjustment structure for television pillow as claimed in claim 6, wherein the bottom of the board seat is formed with multiple insertion sockets under the guide slot, the insertion sockets communicating with the guide slot, the insertion sockets being arranged at different intervals, whereby the support rods of the support rod assembly spaced by different distances can be inserted through suitable insertion sockets.

10. Adjustment structure for television pillow as claimed in claim 7, wherein the insertion sockets of the board seat are outward diverged from upper side to lower side, whereby the support rod assembly can be inserted through the insertion sockets and the board seat can be forward or rearward tilted and adjusted relative to the support rod assembly within the diverging angle of the insertion sockets.

11. Adjustment structure for television pillow as claimed in claim 8, wherein the insertion sockets of the board seat are outward diverged from upper side to lower side, whereby the support rod assembly can be inserted through the insertion sockets and the board seat can be forward or rearward tilted and adjusted relative to the support rod assembly within the diverging angle of the insertion sockets.

12. Adjustment structure for television pillow as claimed in claim 9, wherein the insertion sockets of the board seat are outward diverged from upper side to lower side, whereby the support rod assembly can be inserted through the insertion sockets and the board seat can be forward or rearward tilted and adjusted relative to the support rod assembly within the diverging angle of the insertion sockets.

13. Adjustment structure for television pillow as claimed in claim 1, wherein the support rod assembly includes two opposite support rods and a linking rod connected between the support rods, the support rods being formed with perpendicular transverse worms opposite to each other, the worms having threads in the same direction, two ends of the linking rod being formed with thread holes corresponding to the worms, whereby the worms can be screwed into the thread holes.

14. Adjustment structure for television pillow as claimed in claim 13, wherein the support rods are tightened with the linking rod by screwed members.

15. Adjustment structure for television pillow as claimed in claim 1, wherein a fixing member is fitted on bottom end of each of the support rods, the fixing member having an outer diameter in accordance with the size of the insertion hole of various car models, the fixing member having an inner diameter corresponding to outer diameter of one single type of support rod, whereby with one single type of support rod fitted with different outer diameters of fixing members, the support rod assembly is adaptable to the insertion holes of insertion sections of various car seats.

16. Adjustment structure for television pillow as claimed in claim 14, wherein a fixing member is fitted on bottom end of each of the support rods, the fixing member having an outer diameter in accordance with the size of the insertion hole of various car models, the fixing member having an inner diameter corresponding to outer diameter of one single type of support rod, whereby with one single type of support rod fitted with different outer diameters of fixing members, the support rod assembly is adaptable to the insertion holes of insertion sections of various car seats.

17. Adjustment structure for television pillow as claimed in claim 1, wherein a top end of the fixing member is formed with thrust ribs for more securely connecting with the insertion sections of the seat.

18. Adjustment structure for television pillow as claimed in claim 15, wherein a top end of the fixing member is formed with thrust ribs for more securely connecting with the insertion sections of the seat.

19. Adjustment structure for television pillow as claimed in claim 16, wherein a top end of the fixing member is formed with thrust ribs for more securely connecting with the insertion sections of the seat.

20. Adjustment structure for television pillow as claimed in claim 1, wherein the television frame is fixed on the board seat by adhesion or locking.

21. Adjustment structure for television pillow as claimed in claim 1, wherein the clip member clips a clip sect ion of the board seat to pivotally fix the support rod assembly on the board seat.

22. Adjustment structure for television pillow as claimed in claim 3, wherein the pivot rod is a substantially U-shaped tubular rod, a top section of the pivot rod being bent from the subsidiary board.

23. Adjustment structure for television pillow as claimed in claim 3, wherein the pivot rod is fixed on the subsidiary board by locking members or welding.

24. Adjustment structure for television pillow as claimed in claim 2, wherein the board seat and the subsidiary board are pivotally connected by means of pivotally connecting interlaced connecting blocks respectively disposed on the board seat and the subsidiary board.

25. Adjustment structure for television pillow as claimed in claim 24, wherein each connecting block is a projecting block body, the connecting block having a bight top end.

26. Adjustment structure for television pillow as claimed in claim 24, wherein the connecting blocks are formed with coaxially aligned holes, a shaft being passed through the holes to serially pivotally connect the connecting blocks.

27. Adjustment structure for television pillow as claimed in claim 25, wherein the connecting blocks are formed with coaxially aligned holes, a shaft being passed through the holes to serially pivotally connect the connecting blocks.

28. Adjustment structure for television pillow as claimed in claim 2, wherein the board seat and the subsidiary board are pivotally connected by means of a pivot rod and a clip body, the clip body clipping the pivot rod and the board seat so as to pivotally connect the subsidiary board with the board seat.

29. Adjustment structure for television pillow as claimed in claim 1, wherein the board seat and the subsidiary board are enclosed by a soft wrappage to provide a soft supporting effect for a neck.

30. Adjustment structure for television pillow as claimed in claim 2, wherein the board seat and the subsidiary board are enclosed by a soft wrappage to provide a soft supporting effect for a neck.

31. Adjustment structure for television pillow as claimed in claim 3, wherein the board seat and the subsidiary board are enclosed by a soft wrappage to provide a soft supporting effect for a neck.

32. Adjustment structure for television pillow as claimed in claim 24, wherein the board seat and the subsidiary board are enclosed by a soft wrappage to provide a soft supporting effect for a neck.
